(19) United States
(12) Patent Application Publication
(10) Pub. No.: US 2017/0289348 A1
(43) Pub. Date: Oct. 5, 2017

(54) Method of connection of outside callers to the electronic control system subscribers for information on objects of property

(71) Applicant: Oleksandr Anatoliiovych CHEKMAROV, Kyiv (UA)

(72) Inventor: Oleksandr Anatoliiovych CHEKMAROV, Kyiv (UA)

(21) Appl. No.: 15/509,287

(22) PCT Filed: May 21, 2015
(86) PCT No.: PCT/UA15/00045

§ 371 Date: Mar. 7, 2017

(30) Foreign Application Priority Data
Sep. 8, 2014 (UA) U2014 09809

(51) Int. Cl. H04M 3/42; H04L 29/12; H04M 3/493

(52) U.S. Cl. CPC H04M 3/42008; H04M 3/493; H04L 61/1594; H04M 3/42195; H04M 3/42382; H04M 3/42221; H04M 2203/306; H04M 2203/558; H04M 2242/12

(57) ABSTRACT

The claimed method of connection of outside callers to electronic control system subscribers provides for communication sessions between the callers and the subscribers to inform the subscribers about their property's objects, such as vehicles, buildings, apartments, pets, etc., ensuring personal data confidentiality therebetween. The method contemplates application of an electronic control system, including an electronic computing device configured to connect to the Internet, mobile and fixed-line communication networks connected to telephone numbers, network addresses of instant messaging systems and addresses of network accounts, application of IVR interactive voice response systems, and provides for an algorithm of indirect connection of the callers and subscribers. The addresses of network instant messaging systems, network accounts, and other personal data are used only for connection to the system of the callers and subscribers while are not transferred to these parties, thereby ensuring confidentiality therebetween.

### CROSS-REFERENCE TO RELATED APPLICATIONS

This application is a U.S. national stage application of an international application PCT/UA2015/000045 filed on 21 May 2015 claiming priority of Ukrainian patent application UA u201409809 filed on 8 Sep. 2014.

### FIELD OF THE INVENTION

The present method of connection of outside callers to the electronic control system subscribers for information on objects of property relates to the field of telecommunications and is designed to provide communication sessions between the outside callers and system subscribers to inform the system subscribers about the objects of their property ensuring confidentiality of personal data between these parties.

### BACKGROUND OF THE INVENTION

Currently, there is a widespread tendency to leave a car owner's cell phone number in a car on a place visible from outside. If the car prevents movement or hampers exit to other persons or is in the reserved parking space or stand, etc., any other persons can contact the car owner on this phone number to resolve issues related to the car. However, in this case, the car owner that left his cell phone number may not always be able to answer the phone call associated with his car for various reasons and can not know that the missed call pertained to his car, so he can fail to timely respond to this message or at all miss this message. In addition, giving the telephone number, which relates to personal data, to all interested and in connection to the car which has license plate is not advisable, because it may contribute to deceptive practices of other persons, use of the number in the intrusive address advertising or assist the other party to the conflict in the case of its occurrence in connection with the use of the car. And the possibility of conflict or liability associated with the specified car, taking into account the possibility of determining the phone number, also does not promote the use of this method of communication with other people.

In the prior art there is a method of communication by other people with a car owner, which involves the use of a specialized electronic control system, through which, by automated switching through channels, an outside caller is connected to subscribers of the system for information on vehicles belonging to the subscribers of the system. The said technical solution of the method of communication has a special name “OkPark” and is described on the website: http://www.okpark.ru/ and is selected as the closest analog. This solution provides for the registration of a vehicle owner in an electronic control system, whereafter he becomes a subscriber of the system, obtaining data on a system subscriber's vehicle from an outside caller through a short number and sending automatically generated output data associated with the data on the vehicle to the system subscriber. The data sent to the system subscriber include a contact phone number of an outside caller and an additional optional text message.

I.e. in this method of communication the anonymity of the system subscriber before other persons is ensured, but the telephone number of the outside caller is disclosed to the system subscriber, which is a big disadvantage. In addition, this technical solution provides for a possibility to initiate a communication session over a short number only on a subscriber's mobile phone number. However, at this time, given the mass distribution of mobile devices and development of communication, there are widespread possibilities of communication using various communication channels, including the Internet, and thus including the IM (instant messengers) network addresses and network accounts addresses (accounts of any social or other networks and services, for example, Skype or Viber). Modern communication devices can be specially customized just for communication through these means. Thus, the described method of subscribers' communication has significant limitations in the application. In addition, the mandatory need for manual input of a text message by an outside caller is uncomfortable and also does not add to the use of this method by an outside caller. Moreover, it minimizes the use of the solution “OkPark” by disabled people, in adverse weather conditions and in emergency situations. The mentioned electronic control system registers only the car registration numbers and provides for a single short number to initialize communication, which significantly limits the field of use of such a solution. The feedback communication with the outside caller is provided in this electronic control system by way of text messages that limits the possibilities of an outside caller to provide detailed and accurate information to be sent to the system subscriber. Lack of direct communication between the outside caller and the system subscriber contributes to conflict between them, in view of the cases of application of this method of communication, that promotes refusal from using this technical solution. In addition, this method does not provide for an outside caller a confirmation of notification received by the system subscriber. This method also has a limitation in the number of phone numbers of the system subscriber—namely, only one number on which the communication is sent that substantially reduces the effectiveness of the message. In addition, this method provides for its application only with respect to vehicles and is not designated for the use in relation to any other types of assets, such as buildings, houses, personal property, including small ones, pets, etc.

So, taking into account this problem and the existing need, the inventor set an objective to create a method of connection of outside callers to electronic control system subscribers for information on objects of property belonging to such system subscribers, which eliminates the disadvantages of existing technical solutions, ensures expansion of the field of use, particularly about various objects of property, and ensures confidentiality between the parties.

### OBJECT AND SUMMARY OF THE INVENTION

The objective is achieved by the different method of connection of outside callers to the electronic control system subscribers for information on objects of property by automated switching via communication channels with the application of the electronic control system as described below.

The invention presents a method of connection of outside callers to the electronic control system subscribers for information on objects of property by way of automated switching via communication channels with the application of the electronic control system, wherein the specified parties are connected via communication channels with an option to choose a communication network subject to preset access authorizations to message transmission networks and applying the specified electronic control system that is designed to embody the claimed method according the preset algorithm, and which is a hardware and software complex based on at least one electronic computing device configured to connect to the Internet, mobile and fixed-line communication networks, and to store and process system subscriber's registration data, receive messages from outside callers and send automatically generated output data pertaining to the data on the system subscriber's object of property to the system subscriber, in particular, the above electronic control system, contains server software recorded in the processing unit that is designed to process input data both from at least one system subscriber and from at least one outside caller and to control the choice of the output data based on the input data, to control the processes of recording, selection, reading and retrieval of data from at least one database that is placed in the electronic control system, which is created and controlled by the database control system and is designed to collect, systematize and store data, which include, at a minimum, system subscribers' registration information, a set of IVR pre-recorded voice message and information on the history of outside callers' references, and the registration data of each system subscriber include an array of at least one cell that is associated with the contact information of a system subscriber, where the contact information of the system subscriber is at least one phone number and/or at least one address of network instant messaging system and/or at least one address of a network account, and at least one cell containing at least one property object identifier that is associated with this system subscriber, and the processing unit includes at least one operating system to service the specified server software and database control system, and according to this method the subscribers are connected by switching the system subscriber's terminal to an outside caller through communication channels, where after receiving via communication channels of a call from the outside caller's terminal, to check the registration and property object identifier activation in the above-described database, a launch of a series of pre-recorded IVR voice messages is triggered to offer an outside caller to input a property identifier, and using the above server software, the number of the outside caller is saved in the in temporary memory of the database control system, and after receiving a property object identifier its availability and activation are checked, and if after the check up the specified property object identifier is not found in the database, then the outside caller is offered by the pre-recorded IVR voice message to re-enter the property identifier, and if after the check up the specified property object identifier is found in the database, then its activation is checked, and in the absence of the activation of this property object identifier, the outside caller is informed with a pre-recorded IVR voice message on the refusal and/or inability to establish a connection to the relevant system subscriber, and if after the checkup it is found that the property object identifier is activated, the outside caller is confirmed with pre-recorded IVR voice message on the acceptance of the object property identifier, and thereafter the outside caller's contact number is saved in the database in the specially designated history of outside callers' references, and after the confirmation of the acceptance of the property object identifier, via the above server software, a call to the system subscriber is initiated using the first contact data of the system subscriber from at least the first cell of the above database, and in the absence of a connection on the first contact data, the server software sequentially initiates a call using any available contact information of the system subscriber from the next available cell of the aforementioned database, and after the above call initiation to all the above contact data recorded in the cells of the above database, in the absence of communication to or call rejection by the system subscriber, the described initiation of calls to each of the contact information of the system subscriber from each database cell is repeated after a time interval subject to a programmed number of repeated calls and time intervals, whereafter, if there is no connection to or the call is rejected by the system subscriber, a text message is generated and sent by the said electronic control system to the outside caller with the information about the temporary inability to connect to the system subscriber and/or a proposal to re-initiate a call, or a pre-recorded IVR voice message is reproduced to the outside caller on the temporary unavailability of the system subscriber and/or a proposal to re-initiate the call later, and if the call is accepted by the system subscriber, a pre-recorded IVR voice message is reproduced to the system subscriber with a proposal to, by dialing an additional service number using the input device of the subscriber's terminal, initiate a connection to the outside caller and/or a proposal to initiate sending a text message to an outside caller with information on the system subscriber's response time to the respective aforementioned subscriber's property, and if the electronic control system receives a messages from the system subscriber on the initiation of the communication with the outside caller, the parties are connected until the first interruption of the conversation by one of the parties and/or till the end of the programmed time limit of the session, and if the electronic control system receives a messages from the system subscriber on the initiation of the above text message sending to the outside caller, a text message indicating the appropriate system subscriber's response time to the respective aforementioned subscriber's property is generated and sent to the outside caller, or a voice message generated using IVR system is reproduced to the outside caller indicating the appropriate system subscriber's response time to the respective aforementioned property object.

The aforementioned method of connection of outside callers to the electronic control system subscribers for information on objects of property further contemplates recording the conversations during the communication sessions to be stored in the respective library of the above database; for the activation of the property object identifier a text message is received from the system subscriber that contains, in particular, an alphanumeric sequence that is associated with the identifier of the property object, and contact information of the system subscriber, and the contact information of the system subscriber is at least one phone number and/or at least one address of the network instant messaging system and/or at least one address of a network account, as well as the personal data on the name, age and location of the system subscriber.

The aforementioned method of connection of outside callers to the electronic control system subscribers for information on objects of property further contemplates applying the above server software being configurable to personal preferences of each system subscriber, including in particular the language of pre-recorded voice IVR commands, female or male voice to reproduce the pre-recorded IVR voice commands.

### PREFERRED EMBODIMENTS OF THE INVENTION

In the proposed method the switching between said subscribers is done through communication channels with an option to choose a communication network subject to preset access authorizations to message transmission networks and applies the specified electronic control system that is designed to embody the claimed method according the preset algorithm.

This electronic control system is a hardware and software complex based on at least one electronic computing device configured to connect to the Internet, mobile and fixed-line communication networks, and to store and process system subscriber's registration data, receive messages from outside callers and send automatically generated output data pertaining to the data on the system subscriber's object of property to the system subscriber.

In particular, the electronic control system, contains server software recorded in the processing unit that is designed to process input data both from at least one system subscriber and from at least one outside caller and to control the choice of the output data based on the input data. The server software is also designed to control the processes of recording, selection, reading and retrieval of data from at least one database that is placed in the electronic control system.

The said at least one database is created and controlled by the database control system and is designed to collect, systematize and store data, which include, at a minimum, system subscribers' registration information, a set of IVR pre-recorded voice message and information on the history of outside callers' references.

The registration data of each system subscriber include an array of at least one cell that is associated with the contact information of a system subscriber, where the contact information of the system subscriber is at least one phone number and/or at least one address of network instant messaging system and/or at least one address of a network account, and at least one cell containing at least one property object identifier that is associated with this system subscriber.

The above processing unit of the electronic control system includes at least one operating system to service the specified server software and database control system.

According to this method the subscribers are connected by switching the system subscriber's terminal to an outside caller through communication channels.

According to this method, after receiving via communication channels of a call from the outside caller's terminal, to check the registration and property object identifier activation in the above-described database, a launch of a series of pre-recorded IVR voice messages is triggered to offer an outside caller to input a property identifier. After that, using the above server software, the number of the outside caller is saved in the in temporary memory of the database control system. And after receiving a property object identifier its availability and activation are checked.

If after the check up the specified property object identifier is not found in the database, then the outside caller is offered by the pre-recorded IVR voice message to re-enter the property identifier. If after the check up the specified property object identifier is found in the database, then its activation is checked. In the absence of the activation of this property object identifier, the outside caller is informed with a pre-recorded IVR voice message on the refusal and/or inability to establish a connection to the relevant system subscriber. If after the check up it is found that the property object identifier is activated, the outside caller is confirmed with pre-recorded IVR voice message on the acceptance of the object property identifier, and thereafter the outside caller's contact number is saved in the database in the specially designated history of outside callers' references.

After the confirmation of the acceptance of the property object identifier, via the above server software, a call to the system subscriber is initiated using the first contact data of the system subscriber from at least the first cell of the above database. In the absence of a connection on the first contact data, the server software sequentially initiates a call using any available contact information of the system subscriber from the next available cell of the aforementioned database.

After the above call initiation to all the above contact data recorded in the cells of the above database, in the absence of communication to or call rejection by the system subscriber, the described initiation of calls to each of the contact information of the system subscriber from each database cell is repeated after a time interval subject to a programmed number of repeated calls and time intervals.

If there is no connection to or the call is rejected by the system subscriber, a text message is generated and sent by the said electronic control system to the outside caller with the information about the temporary inability to connect to the system subscriber and/or a proposal to re-initiate a call, or a pre-recorded IVR voice message is reproduced to the outside caller on the temporary unavailability of the system subscriber and/or a proposal to re-initiate the call later.

If the call is accepted by the system subscriber, a pre-recorded IVR voice message is reproduced to the system subscriber with a proposal to, by dialing an additional service number using the input device of the subscriber's terminal, initiate a connection to the outside caller and/or a proposal to initiate sending a text message to an outside caller with information on the system subscriber's response time to the respective aforementioned subscriber's property.

If the electronic control system receives a messages from the system subscriber on the initiation of the communication with the outside caller, the parties are connected until the first interruption of the conversation by one of the parties and/or till the end of the programmed time limit of the session.

If the electronic control system receives a messages from the system subscriber on the initiation of the above text message sending to the outside caller, a text message indicating the appropriate system subscriber's response time to the respective aforementioned subscriber's property is generated and sent to the outside caller, or a voice message generated using IVR system is reproduced to the outside caller indicating the appropriate system subscriber's response time to the respective aforementioned property object.

Also the described method of connection of outside callers with the electronic control system subscribers for information on objects of property may provide for the recording of the conversations during the communication sessions using the above control system to be stored in the respective library of the above database. And for the activation of the property object identifier a text message is received from the system subscriber that contains, in particular, an alphanumeric sequence that is associated with the identifier of the property object, and contact information of the system subscriber. The contact information of the system subscriber is at least one phone number and/or at least one address of the network instant messaging system and/or at least one address of a network account, as well as the personal data on the name, age and location of the system subscriber.

In addition, this method of connection of outside callers to the electronic control system subscribers for information on objects of property may provide for the application of the above server software configurable to personal preferences of each system subscriber, including in particular the language of pre-recorded voice IVR commands, female or male voice to reproduce the pre-recorded IVR voice commands.

As can be seen, in this case the IVR system means an interactive voice response system—IVR, which is an interface that allows the user by voice and, in many cases, using hardware (usually this means is a keyboard of the terminal) to communicate with a computerized system.

The bellow detailed description of the embodiment of the method of connection of outside callers to the electronic control system subscribers for information on objects of property reveals the preferred embodiment of the present technical solution and is provided only for the understanding of this process. The claimed method is not limited by only this detailed description presented for the information purposes. The below description includes the preferred and optimal embodiments of the proposed technical solution for practical and commercial applications.

According to this method of connection of outside callers to the electronic control system subscribers for information on objects of property the switching is done through communication channels with an option to choose a communication network subject to preset access authorizations to message transmission networks with the use of the electronic control system. Here the system subscriber means an end user of services provided for using the electronic control system. It is obvious that the system subscriber does not interact with the electronic control system directly, but uses material and technical means, in particular terminals, sending therewith registration data to the electronic control system and performing other actions described below. The outside caller means a temporary consumer of the services of call switching to the system subscriber using a terminal of the outside caller through the contact details that are part of the registration data provided by the system subscriber to the electronic control system with the purpose to resolve any issues related to the property object owned by the system subscriber, as the data on the system subscriber's property object were provided as part of the registration data to the electronic control system, and an outside caller is connected to the system subscriber by the outside caller's reference to the electronic control system.

The specified electronic control system is designed to embody the claimed method using a preset algorithm and is a hardware and software complex based on at least one electronic computing device configured to connect to the Internet, mobile and fixed-line communication networks, and to store and process system subscriber's registration data, receive messages, that may include an identifier of the system subscriber's property object, from outside callers and send automatically generated output data pertaining to the data on the system subscriber's object of property to the system subscriber.

For multi-channel data exchange via communication channels with the servers of mobile operators, servers of Internet access providers and servers of any other network technologies, the electronic computing device includes a network-to-network interface. The network-to-network interface is designed to harmonize data exchange protocols used in these networks. This is achieved by addressing to the network protocols library that is connected to the network-to-network interface, and subsequent rapid conversion of data. Upon receipt of an incoming message from an outside caller the used network protocol is determined. When establishing the connection with the system subscriber, the network protocol used for switching is established. Where for the connection of an outside caller and the system subscriber several network protocols are used, the conversion will be made both upon receipt and transfer of data. If one network protocol is used, the data is transmitted and accepted under this protocol.

The server software application is designed to process the input data both from at least one system subscriber and from at least one outside caller and to control the choice of output data based on the input data, control the processes of recording, selection, reading and retrieval of data from at least one database.

The database is placed in the electronic control system and is created and managed by the database control system and is designed to collect, systematize and store data, which include, at a minimum, system subscribers' registration information, a set of IVR pre-recorded voice messages and information on the history of outside callers' references and may include the library of recorded conversations during the communication sessions. The registration data of each system subscriber include an array of at least one cell that is associated with the contact information of the system subscriber, where the contact information of the system subscriber is at least one phone number and/or at least one address of network instant messaging system and/or at least one address of a network account, and at least one cell containing at least one property object identifier that is associated with this system subscriber.

The library of recorded conversations during the communication sessions is an auxiliary means. Talk time during the communication session is a specific duration of time defined by hardware. The duration of the communication session may be less than that pre-defined by the hardware if one of the participants interrupted the conversation session. The completed communication sessions can be stored in the database with the specification of the period of storage. If the storage period is specified as unlimited or the maximum possible period of storage, then the data is stored for a period until a system subscriber uses electronic control system which is established either by the advance payment for the services of the use of the electronic control system, or by any other methods, which nature does not affect the claimed method. If the system subscriber sets a specific period of storage of records of conversations during the communication sessions, then after the expiry of this period the records are removed from the database. A system subscriber can set user preferences with the abolition of storing records of conversations during the communication sessions and change the settings as desired.

The temporary memory refers to random access memory and is designed for temporary or buffer storage of data obtained through communication channels and data that are a result of the processing by software and are intended for storage in a database and sending by the server to the end user, which can be either an outside caller or a system subscriber.

The processing unit comprises at least one operating system to service the above server application and database control systems. The processing unit is designed to run and operate a software installed in the server. The speed of input data packages processing does not depend on the type of information that is encoded in these packages, but in practice there is a direct dependence on the number of packages. The load on the processing unit can be reduced at least in two ways: the use of a more capacitive coding method, reducing the length and number of data packages. This technical solution implies the application of a combination of both above methods to reduce the load on the processing unit. The first method involves multimedia coding with decreasing sampling rate and limiting the range of audio signal using software. And the quality of the stored media data should be sufficient for unambiguous auditory perception. This reduces the amount of data to be further processed and stored in the database.

The second method implies the use of a set of predefined IVR voice commands and text messages in which the commands are recorded under certain numbers and can be reproduced and stored in the history of the references of the initiators of communication sessions using these numbers. In both methods used there is a decrease of the load on the processing unit, rationalized use of temporary memory resources, and reduction of the load on the data connection buses.

According to the claimed method, the subscribers are connected by switching of a system subscriber's terminal to an outside caller's terminal through communication channels. After receiving a call through the communication channels from the outside caller's terminal, for the check up of the registration and activation of the property object identifier in the above database, a series of pre-recorded IVR voice messages is triggered to offer an outside caller to input the property object identifier.

According to this claimed method the indirect methods of switching are used where an outside caller establishes a communication session with a system subscriber via the electronic control system as above, but not directly. This electronic control system ensures confidentiality of data pertaining to both outside caller and system subscriber by maintaining their contact information in the database without providing this data in any human-perceptible form to neither party to the communication session. Also, the embodiment of the claimed method implies the possibility to encrypt both messages and the communication in general. This allows to increase the resistance of a communication session to any external disturbance, interception and interference in the communication session.

The electronic control system includes a processor unit that contains software for the processing of input data and controlling the selection of the output data. With the use of the above server software, the number of an outside caller is stored in the database of the electronic control system in the temporary memory. The above software application allows to configure personal settings for each system subscriber, including in particular the language of pre-recorded IVR voice commands, female or male voice to reproduce the pre-recorded IVR voice commands. This allows to expand the number of potential consumers of the claimed method by extending the functional features and increasing settings for a particular user.

The electronic control system is designed with a possibility to obtain registration data of the system subscriber. For the activation of the property object identifier a text message shall be received from the system subscriber that contains, in particular, an alphanumeric sequence that is associated with the identifier of the property object, and contact information of the system subscriber, where the contact information of the system subscriber is at least one phone number and/or at least one address of the network instant messaging system and/or at least one address of a network account, e.g. addresses of network messengers and/or accounts as well as personal data on the name, age and location of the system subscriber.

The use of the contact information in both cellular communication and Internet technologies allows to extend the use of the claimed method, as it provides more opportunities for an outside caller to establish a communication session with the system subscriber. Of course, the technologies involved should support voice messaging.

The electronic control system contains a database that stores customer registration data, a set of predefined IVR voice commands, outside callers references history data and a multimedia library of records of communication sessions.

A system subscriber is provided with a special phone number for calling to the electronic control system, e.g. a short number or another communication detail and his property object identifier in the form of an alphanumeric or QR-code or another bar code. The specified telephone number or another communication detail and its property object identifier can be displayed on a special card which the subscriber places on the appropriate property object, or in any other way on this property, for example, behind the car glass, on the door of the house or apartment, on pet collar, etc. The said telephone number or another communication detail and the property object identifier can be displayed together in one bar code.

Along with these details there can be placed a warning label explaining how to use these details for contacting the owner of the property. In the case of the use of bar codes, an outside caller can use his user terminal (mobile phone, smart-phone, tablet, “smart watches”, etc.) that has a camera and software for recognition of two-dimensional codes to read the bar code and thus obtain the system subscriber's property object identifier, a telephone number or another other communication detail to connect to the electronic control system. The outside caller initiates a call to the specified telephone number or another detail and provides the identifier of data on the system subscriber's property object.

The electronic control system is designed so that to receive through the communication channels a call from an outside caller, receive information about the system subscriber's property object to perform the procedure of checking the system subscriber's property object identifier in the data base and its current activation.

After receiving a call through the communication channels from the outside caller's terminal, for the check up of the registration and activation of the property object identifier in the above database, a series of pre-recorded IVR voice messages is triggered to offer an outside caller to input the property object identifier.

Depending on the above form of property object identifier, it can be input in some way to the outside caller's terminal, e.g. using the keyboard, and sent to the electronic control system. In addition, the application of the IVR system may involve the use of phonemic analysis of the outside caller's speech for the selection and recognition of data pertaining to the system subscriber's property object. In this case, pre-recorded IVR voice messages may notify on the need for clear of pronunciation. And using the above control system, if necessary, the conversations during the communication sessions can be recorded for being stored in the appropriate library of the above database.

If after the check up the specified property object identifier is not found in the database, then the outside caller is offered by a pre-recorded IVR voice message to re-enter the property identifier. If after the check up the specified property object identifier is found in the database, then its activation is checked. In the case of speech recognition, the re-entering of the identifier allows to reduce the error of incorrect recognition of voice data. If necessary, for the re-entered identifier data a set selective correlation can be programmed, for example, if the percentage of probable recognition of the identifier upon its pronunciation by an outside caller is less than a preset level, for example less than 70%.

If after the check up the specified property object identifier is found in the database, then its activation is checked. In the absence of activation of this property object identifier, the outside caller is informed with a pre-recorded IVR voice message on the refusal and/or inability to establish a connection to the relevant system subscriber. If after the check up it is found that the property object identifier is activated, the outside caller is confirmed with pre-recorded IVR voice message on the acceptance of the object property identifier.

The electronic control system is designed so that it is able to recognize the contact number of the outside caller through which the call was received. If a contact number of the outside caller is not recognized or was established as hidden, then the outside caller is proposed with a recorded IVR voice message to reveal his contact number, thereby enabling the electronic control system to recognize this number so that it further being saved, processed and possibly used for the communication with this outside caller. And the outside caller is notified, using the above voice commands, that the claimed method of communication is designed for open contact numbers, i.e. where feedback communication is possible.

As it is known, secret contact numbers are not displayed on other terminals or false data is displayed not allowing to establish communication with the owner of such number after disconnecting communication. As already mentioned, an open number is needed to enable the electronic control system communicating with the outside caller, and this number is not transferred to the system subscriber or to any other people.

In addition, an outside caller, following IVR voice messages can request to initiate a call by the electronic control stem to the terminal of the outside caller. After this request, the electronic control system disconnects the communication session with an outside caller and initiates the call to such outside caller using saved contact information. This increases the attractiveness of the claimed system for its use, and serves as an indicator of quality of the algorithm for the recognition, processing, storage and use of the outside callers' contact information.

The electronic control system is designed with a feature to store the contact number of an outside caller in the temporary memory with further possibility to save this number in the permanent memory in the database in the specifically provided for this history of references of external callers. And, considering the specific scope of application of this method of communication, it allows, in the manner prescribed by law, to document the circumstances of communication of outside callers with system subscribers so that the respective materials could be submitted to law enforcement bodies. For example, it allows to save the contact information of outside fraudster callers in cased when they call out the system subscriber to the property object owned thereby with the purpose of robbery. The electronic control system can also receive a command from the system subscriber to block reception of calls from a certain number of an outside caller, if the system subscriber after repeated sessions with the outside caller concluded that any further conversation with an outside caller is undesirable.

After the confirmation of the acceptance of the property object identifier, via the above server software, a call to the system subscriber is triggered using the first contact data of the system subscriber from at least the first cell of the above database. In the absence of a connection on the first contact data, the server software application sequentially triggers a call using any available contact information of the system subscriber from the next available cell of the aforementioned database.

After the above call triggering to all the contact data recorded in the cells of the above database, in the absence of communication or call rejection by the system subscriber, the described initiation of calls to each of the contact information of the system subscriber from each database cell is repeated after a time interval subject to a programmed number of repeated calls and time intervals.

It is possible to make a multiple call to an outside caller or hold him on the line, i.e. without disconnection at the time when the system subscriber is reported on the call on his contact information to resolve the issues concerning the system subscriber's property object.

Upon completion of the described initialization of calls and in the case of unavailability of the system subscriber or his rejection of the call, the described electronic control system can be used to send a text message to the system subscriber with information about the attempt to contact him on his contact information.

If there is finally no connection or the call is rejected by the system subscriber, a text message is sent by the said electronic control system to the outside caller with information about the temporary inability to connect to the system subscriber and/or a proposal to re-initiate a call, or a pre-recorded IVR voice message is reproduced to the outside caller on the temporary unavailability of the system subscriber and/or a proposal to re-initiate the call again.

If the call is accepted by the system subscriber, a pre-recorded IVR voice message is reproduced to the system subscriber with a proposal to, by dialing an additional service number using the input device of the subscriber's terminal, initiate a connection with the outside caller and/or a proposal to initiate sending a text message to an outside caller with information on the system subscriber's response time to the respective aforementioned subscriber's property. I.e. following the commands of the IVR system, the system subscriber makes a choice that is determined by entering certain figures or symbols on the keyboard (input device) of his communication device.

If the electronic control system receives a messages from the system subscriber on the initiation of the communication with the outside caller, the parties are connected until the first interruption of the conversation by one of the parties and/or till the end of the programmed time limit of the session. If the electronic control system receives a messages from the system subscriber on the initiation of the above text message sending to the outside caller, a text message indicating the appropriate system subscriber's response time to the respective aforementioned subscriber's property is generated and sent to the outside caller, or a voice message generated using IVR system is reproduced to the outside caller indicating the appropriate system subscriber's response time to the respective aforementioned subscriber's property.

This reduces the amount of data to be processed and stored in the database, and also reduces the load on the processing unit.

The embodiment of the described method can also include sending to an outside caller and/or system subscriber of text messages and/or IVR voice commands containing advertising information at any stage of application of the claimed method, for example, after initiating a call by an outside caller, after establishing connection with the system subscriber, at the stage of waiting for a response from the electronic control system either by an outside caller or by the system subscribers, etc.

As one can see, the described solution is a method of connection of outside callers to the electronic control system subscribers for information on objects of property belonging to the system subscribers, which eliminates the disadvantages of existing technical solutions, ensures expansion of the field of use, particularly about various objects of property, and ensures confidentiality between the parties.

What is claimed is:

1. The method of connection of outside callers to the electronic control system subscribers for information on objects of property by way of automated switching via communication channels with the application of the electronic control system, wherein the specified parties are connected via communication channels with an option to choose a communication network subject to preset access authorizations to message transmission networks and applying the specified electronic control system that is designed to embody the claimed method according the preset algorithm, and which is a hardware and software complex based on at least one electronic computing device configured to connect to the Internet, mobile and fixed-line communication networks, and to store and process system subscriber's registration data, receive messages from outside callers and send automatically generated output data pertaining to the data on the system subscriber's object of property to the system subscriber, in particular, the above electronic control system, contains server software recorded in the processing unit that is designed to process input data both from at least one system subscriber and from at least one outside caller and to control the choice of the output data based on the input data, to control the processes of recording, selection, reading and retrieval of data from at least one database that is placed in the electronic control system, which is created and controlled by the database control system and is designed to collect, systematize and store data, which include, at a minimum, system subscribers' registration information, a set of IVR pre-recorded voice message and information on the history of outside callers' references, and the registration data of each system subscriber include an array of at least one cell that is associated with the contact information of a system subscriber, where the contact information of the system subscriber is at least one phone number and/or at least one address of network instant messaging system and/or at least one address of a network account, and at least one cell containing at least one property object identifier that is associated with this system subscriber, and the processing unit includes at least one operating system to service the specified server software and database control system, and according to this method the subscribers are connected by switching the system subscriber's terminal to an outside caller through communication channels, where after receiving via communication channels of a call from the outside caller's terminal, to check the registration and property object identifier activation in the above-described database, a launch of a series of pre-recorded IVR voice messages is triggered to offer an outside caller to input a property identifier, and using the above server software, the number of the outside caller is saved in the in temporary memory of the database control system, and after receiving a property object identifier its availability and activation are checked, and if after the check up the specified property object identifier is not found in the database, then the outside caller is offered by the pre-recorded IVR voice message to re-enter the property identifier, and if after the check up the specified property object identifier is found in the database, then its activation is checked, and in the absence of the activation of this property object identifier, the outside caller is informed with a pre-recorded IVR voice message on the refusal and/or inability to establish a connection to the relevant system subscriber, and if after the check up it is found that the property object identifier is activated, the outside caller is confirmed with pre-recorded IVR voice message on the acceptance of the object property identifier, and thereafter the outside caller's contact number is saved in the database in the specially designated history of outside callers' references, and after the confirmation of the acceptance of the property object identifier, via the above server software, a call to the system subscriber is initiated using the first contact data of the system subscriber from at least the first cell of the above database, and in the absence of a connection on the first contact data, the server software sequentially initiates a call using any available contact information of the system subscriber from the next available cell of the aforementioned database, and after the above call initiation to all the above contact data recorded in the cells of the above database, in the absence of communication to or call rejection by the system subscriber, the described initiation of calls to each of the contact information of the system subscriber from each database cell is repeated after a time interval subject to a programmed number of repeated calls and time intervals, whereafter, if there is no connection to or the call is rejected by the system subscriber, a text message is generated and sent by the said electronic control system to the outside caller with the information about the temporary inability to connect to the system subscriber and/or a proposal to re-initiate a call, or a pre-recorded IVR voice message is reproduced to the outside caller on the temporary unavailability of the system subscriber and/or a proposal to re-initiate the call later, and if the call is accepted by the system subscriber, a pre-recorded IVR voice message is reproduced to the system subscriber with a proposal to, by dialing an additional service number using the input device of the subscriber's terminal, initiate a connection to the outside caller and/or a proposal to initiate sending a text message to an outside caller with information on the system subscriber's response time to the respective aforementioned subscriber's property, and if the electronic control system receives a messages from the system subscriber on the initiation of the communication with the outside caller, the parties are connected until the first interruption of the conversation by one of the parties and/or till the end of the programmed time limit of the session, and if the electronic control system receives a messages from the system subscriber on the initiation of the above text message sending to the outside caller, a text message indicating the appropriate system subscriber's response time to the respective aforementioned subscriber's property is generated and sent to the outside caller, or a voice message generated using IVR system is reproduced to the outside caller indicating the appropriate system subscriber's response time to the respective aforementioned property object.

2. The method of connection of outside callers to the electronic control system subscribers for information on objects of property of claim 1, wherein the conversations during the communication sessions are recorded to be stored in the respective library of the above database, and for the activation of the property object identifier a text message is received from the system subscriber that contains, in particular, an alphanumeric sequence that is associated with the identifier of the property object, and contact information of the system subscriber, and the contact information of the system subscriber is at least one phone number and/or at least one address of the network instant messaging system and/or at least one address of a network account, as well as the personal data on the name, age and location of the system subscriber.

3. The method of connection of outside callers to the electronic control system subscribers for information on objects of property of claim 1, wherein the above server software is applied being configurable to personal preferences of each system subscriber, including in particular the language of pre-recorded voice IVR commands, female or male voice to reproduce the pre-recorded IVR voice commands.
